(19) United States
(12) Patent Application Publication
(10) Pub. No.: US 2011/0219918 A1
(43) Pub. Date: Sep. 15, 2011

(54) Dry wall screw embedder

(76) Inventor: James R. Monahan, Toms River, NJ (US)

(21) Appl. No.: 12/932,770

(22) Filed: Mar. 5, 2011

Related U.S. Application Data
(60) Provisional application No. 61/339,843, filed on Mar. 9, 2010.

(51) Int. Cl. B25B 15/00

(52) U.S. Cl. 81/180.1

(57) ABSTRACT

A screw embedder attachment for a hand tool handle is disclosed. The invention allows for the addition of a screwdriver functionality to hand tool handles at the end of the tool handle opposite the working end of the tool. Since the invention is placed over the exterior of the tool handle, it allows for assembly and reassembly of the resulting apparatus without the need for disassembly and reassembly of the tool. The invention may be attached and detached from the tool in a minimal number of steps and without the need for special tools, such that where the invention is not needed for a particular job, but the tool is, the invention may be stowed for later use. The invention may be practiced by hand tool operators desiring to reduce the number of individual tools that need to be carried and exchanged for a particular job. This improves the efficiency of work operations and may reduce the number of related injuries and accidents.

### REFERENCES CITED

Gringer, D. & Chen, Y. F., U.S. Pat. No. 6,530,098, Multiple Tool Devise, Mar. 11, 2003.
Escobedo, A. W. & Escobedo, J. M., U.S. Pat. No. 6,662,521, Multipurpose Drywall Tool, Dec. 16, 2006.
Papadopoulos, G. N., U.S. Pat. No. 5,870,786, Utility Tool, Feb. 16, 1999.
Anderson, W. & Cassutti, P., U.S. Pat. No. 6,131,222, Trowel and Screwdriver Combination Handtool, Oct. 17, 2000.
Huang, C., U.S. Pat. No. 6,182,317, Scraper Having Hammering Head Connected With the Blade, Feb. 6, 2001.
Chacon, A. A., U.S. Pat. No. 5,720,063, Drywall Knife Having A Screwdriver Bit and Dimple Forming Projection, Feb. 24, 1998.
Toal, K. M., U.S. Pat. No. 6,006,384, Drywall Knife With Screwdriver, Dec. 28, 1999.
Marra, D. A., U.S. Pat. No. 5,063,627, Drywall Tool, Nov. 12, 1991.
Clemons, R. W., U.S. Patent Application 20050005365, Drywall Screw Having a Screwdriver Adapter, Jan. 13, 2005.
Stubbs, S., Canadian Patent 2,491,798, Multi-Use Broad Bladed Knife, Jan. 15, 2004.

### BACKGROUND OF THE INVENTION

The general field of this invention is hand tools, and more specifically hand tools for mounting, attaching, hanging, spackling and otherwise finishing dry wall and other wall board materials. This invention also pertains to methods of mounting, attaching, hanging, spackling and otherwise finishing dry wall and other wall board materials, collectively referred to as “boarding attachment” for the purpose of this disclosure. Similarly, the invention relates to methods of finishing wall boarding after attachment, and such methods are collectively referred to as “boarding finishing.”

Spackle knives and other spatula-like hand tools are used to apply filling compound-type mixtures to cover cracks, holes, dimples, seams and other imperfections in dry wall and other wall board materials after hanging these construction materials onto walls, ceilings, roofs and floors. Such hand tools are also used to apply filling compound like wood filler to wood paneling and other covering material made of wood, or faux-wood products. For the purpose of this disclosure, the term “boarding” shall apply to any such interior or exterior wall, ceiling, door, floor and roof covering and finishing materials that may be worked on or finished using hand tools to carry out methods of applying filling compound-like finishing materials like pastes, compounds, fillers, putties and cements. Such finishing materials will be collectively referred to as “finishing compounds” for the purpose of this disclosure. Likewise, hand tools for finishing boarding by applying finishing compound will be collectively referred to as “finishing tools” for the purpose of this disclosure.

Boarding finishing tools typically have only one use—to apply the filling compound. A variety of other hand tools beside spackling knives are usually needed to complete the boarding attachment and boarding finishing. Boarding may be nailed to framing, then to perform boarding finishing steps, nails are then hammered to a depth just under the surface of the boarding to create a dimple without puncturing or otherwise damaging what is often a protective coating or finished surface of the boarding. The top of the handle of finishing tools is often used for this purpose because of the inconvenience of carrying and using a hammer while performing boarding finishing.

Alternatively, boarding may be attached to framing with screws, often specially designed for use in boarding attachment, as in drywall screws. This is the predominant attachment technique used by boarding attachment and finishing professionals. A power drill is often used for boarding attachment using screws, but the resulting depth of the screws is most often quite variable. So, to ensure a proper look after finishing, hand tool screwdrivers are used to adjust the screw depth to optimal positions prior to finishing steps. The goal of adjusting the screw depths is also to create a dimple in the boarding prior to finishing steps with boarding finishing tools. This means that to perform the various boarding finishing steps, a screw driver hand tool, in addition to the boarding finishing tools, must be carried by the operator, and used interchangeably throughout the various steps. Yet, depending on the nature of the particular job being performed, the operator may dispense with one or the other of these, and other hand tools.

Combination screwdriver and finishing tools exist that provide some of the benefits as stated above, but are designed in such a way that operator use may be burdensome, and the two or more functionalities are inconveniently separable. U.S. Pat. No. 6,662,521 (Escobedo & Escobedo) integrates a screwdriver bit into the finishing tool handle, and requires inconvenient disassembly of the entire tool in order to remove the screwdriver bit functionality from the tool when its presence is not desired by the operator. U.S. Pat. No. 6,530,098 (Gringer & Chen) provides for a detachable screw driver bit to address the problem of inconvenient disassembly mentioned above, but the bit is not as securely attached as may be desirable to many operators. It employs spring-like “flexible fingers” which are prone to wearing out over time, and thus loosening their grip upon the screw driver bit attachment. Such a small object as the bit may thus fall out during use and be hard to find by the operator. Likewise, loosened grip springs are not easily replaced, and the entire finishing tool handle, if not the entire tool itself, would need to be replaced. U.S. Patent Application 20050005365 (Clemons) discloses a similar set up to Gringer & Chen, and likewise is not the optimal operator solution for many of the same reasons.

U.S. Pat. Nos. 5,870,786 (Papadopoulos), 6,131,222 (Anderson & Cassutti), 5,063,627 (Marra) and 6,006,384 (Toal) provide a screwdriver functionality that is integrated into the handle of a finishing tool affixed on a swivel mechanism that allows the operator to take it out only when needed. These solutions, however, add additional weight to the finishing tool when the additional functionality is not needed. When the finishing tool blade is worn out, the entire tool needs to be replaced at added expense than the typical single-function finishing tool. Canadian Patent 2,491,798 (Stubbs) provides the same benefits and attendant drawbacks as Anderson & Cassutti, Papadopoulos, Marra, and Toal by way of a lever mechanism rather than a swivel.

U.S. Pat. No. 6,182,317 (Huang) provides for a removable screw bit functionality for a finishing tool, with the attachment placed into a slot in a finishing tool handle to be secured with a screw and bolt, or other means. Like for Gringer & Chen, this requires a multitude of inconvenient disassembly steps to remove the screw driver functionality and reassemble the finishing tool when the attachment is not needed for a particular job. U.S. Pat. No. 5,720,063 (Chacon) discloses a similar set up “embedded within and rigidly attached to the handle” of the finishing tool. If permanently attached, disassembly is possible only by destroying the handle leaving uncomfortable shards. If affixed via screw as in Huang, then disassembly requires at least two steps. Either way, disassembly and reassembly of Haung and Chacon requires more than one step, and thus may be burdensome and inconvenient for the operator to deploy and use in the field.

The present invention provides an effective solution to the problem left unaddressed by the aforementioned references. The attachment of the invention to a finishing tool handle is simple and secure. It allows for fewer steps in assembly and disassembly of the screwdriver functionality attachment from the finishing tool, and is fully adaptable to most any single-function finishing tool. Thus, when the finishing tool needs to be replaced, the simple and durable invention described herein can be easily used with the new finishing tool, and no additional cost is incurred. Similarly, when the screwdriver functionality provided by this invention is not desired for a particular job, the operator may use the finishing tool without the burden of additional unneeded weight. Furthermore, the size of the disclosed attachment is not so small that loss will be a significant problem, yet is not so large as to be cumbersome to use and store.

### BRIEF SUMMARY OF THE INVENTION

This invention improves upon existing tools and methods in boarding attachment and finishing. The invention is attached to the top of the handle of a finishing tool and allows for the convenient addition of a screwdriver functionality to the hand tool. The invention consists of an open ended, suitably sized bracket with a screwdriver bit welded, or otherwise securely attached, to the top of the bracket. The screwdriver bit faces away from the open end of the bracket and away from the working end of the finishing tool. This bracket with the screwdriver bit attached to it is then fitted over the exterior portion of the end of the finishing tool handle and removably attached to the handle by conventional means, as in a suitably sized nut and bolt. Most single function finishing tools on the market have a hole in the handle, so attachment is quick and easy. However, if needed, it is a simple matter to drill a hole through the handle of the finishing tool prior to attaching and using the invention. The need for this step should be exceedingly rare in practice.

The resulting apparatus, after being attached to the finishing tool handle, will eliminate the need to carry and use a screwdriver while performing the various boarding finishing steps after the boarding has been attached by way of screws. This invention significantly increases the efficiency of these operations, and the ease of assembly and disassembly over existing tools allows for dispensing with the attachment in fewer steps than previous solutions when the need for the screwdriver functionality is not present for a particular job.

### BRIEF DESCRIPTION OF THE DRAWINGS

FIGS. 1A, 1B, 1C, and 1D are front, top, left-, and right-side views of the claimed invention, respectively.

FIG. 2 is a perspective view of the attachment of the claimed invention to the top of a finishing tool handle prior to employing it for boarding finishing.

### DETAILED DESCRIPTION OF THE INVENTION

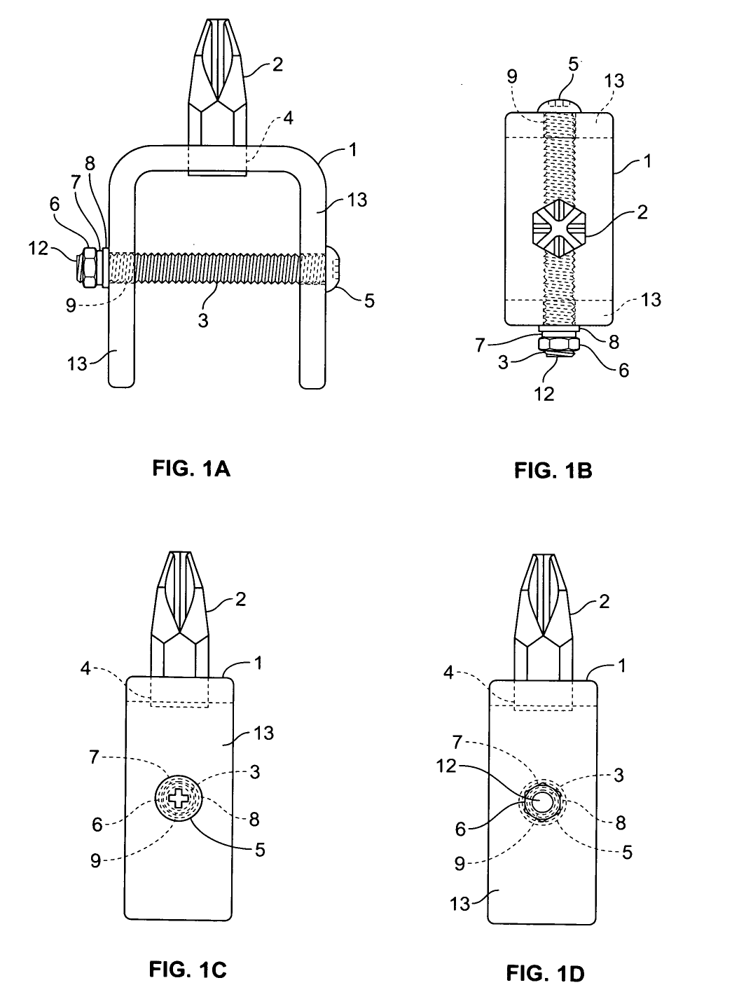

As shown in FIGS. 1A, 1B, 1C, and 1D, the screwdriver bit 2 is attached to the top of the open ended bracket 1 by inserting the bit into a bit hole 4 and securing it, as by a weld. In the preferred embodiment the bit is the Phillips type, as that is predominantly used in dry wall and other special boarding attachment screws. Any other screwdriver bit design may also be employed. Use of the bit hole may be substituted by attaching the bit any other suitably way, such as with a weld or cement, onto the top of the bracket. In the preferred embodiment, the screwdriver bit is attached at a right angle to the center of the top of the bracket, but it may also be secured at any other angle or at any other location on the top of the bracket, the exterior sides of the two bracket legs, or at various combinations thereupon. Alternatively, the entire attachment including the bit and bracket, less the nut, bolt and any washers or spacers, may be molded as one or more pieces, or fabricated by any other means well known by those skilled in the art. The preferred material of the bracket and bit is a metal, but any other suitable material, or combinations of material, may be used. Likewise, the preferred material for the nut, bolt, and any washers or spacers is a metal, but any other suitable material, or combinations of material, may be used. In the preferred embodiment, the bracket is U-shaped with a partially flattened top, and all the corner edges of the bracket are rounded and rendered smooth so as to prevent discomfort and injury during handling and use.

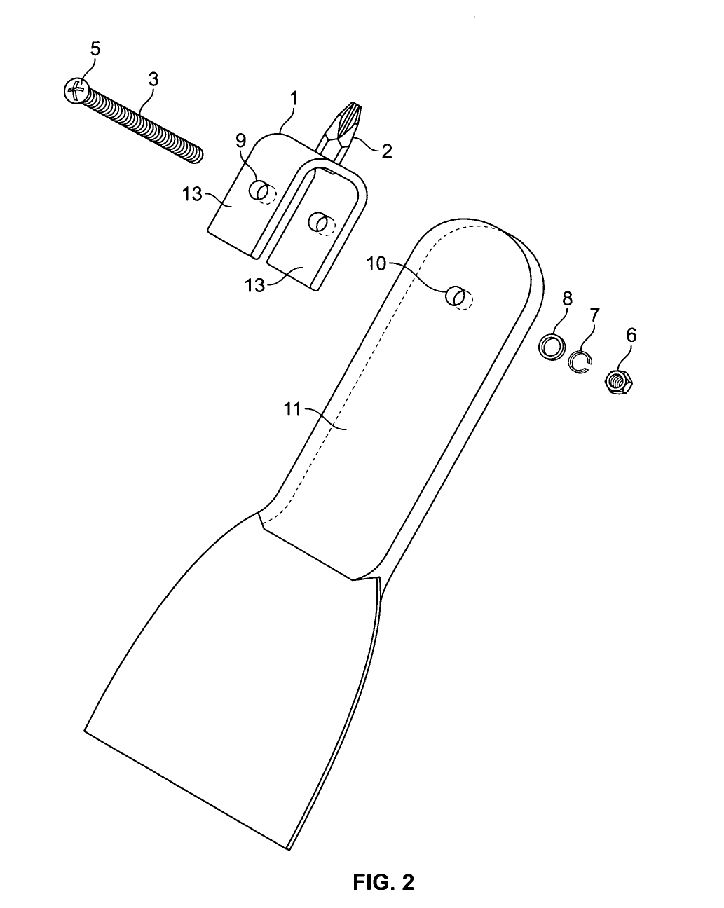

Through the two legs 13 of the bracket are drilled or molded bolt holes 9, through which the threads 3 of a suitably sized bolt 5 are inserted after the bracket has been fitted over the handle hole 10 of the handle 11 of a finishing tool, as shown in FIG. 2. In the preferred embodiment, the bolt 5 is a rounded head bolt. The invention is secured to the handle with a nut 6, and if desired, a spring washer 7 and a ring washer 8 may be included. Any other suitable type and combination, including the complete absence of washers may employed as desired. Where the width between the bracket legs exceeds the thickness of the finishing tool handle, one or more spacers may be employed to reduce wobbling. Use of such spacers may be desirable, but is not necessary to practice the disclosed invention. The spacers may be threaded onto the bolt after the bolt is passed through one of the holes in the bracket and before being fitted onto the handle of the fitting tool. The spacers may also be secured or fitted directly to interior surface locations of one or both of the bracket legs. The preferred embodiment uses a threaded bolt with a rounded tip 12, and protrudes no more than necessary, if at all, beyond the outside surface of the securing nut after the nut is attached to the bolt.

Any other suitable ways to attach the invention to the handle of a finishing tool, like rivets, clips, wing nuts, slots, springs, bands, tap screws and the like may be employed. The desired attachment, regardless of the specific type, will allow for the invention to be fitted over the exterior of the fitting tool handle and allow the convenient assembly and disassembly of the apparatus in as few steps, and using as few additional tools, as possible. For example, attachment of the invention to the fitting tool handle by way of a bolt with self-securing head fitted into either of the exterior surfaces of the bracket legs about the bolt holes and a wing nut requires no additional tools other than the operator's hands.

The interior and exterior widths between the legs of the bracket, and the lengths of the bolt and the bracket legs and top portion, may be varied to accommodate various sizes of finishing tool handles. Varying the sizes thereof does not necessarily introduce any change in the set up or the method of using the claimed invention. The bracket configuration of the base of the invention may take varying forms. The U-shaped bracket configuration may also be fabricated from a flexible yet sturdy material such that a single item of the invention may be able to be accommodated to varying shapes and sizes of tool handles. Similarly, the bracket configuration for the base may be substituted by a cup configuration which may likewise be flexible so as to accommodate varying shapes and sizes of tool handles. In either, or equivalent configurations, the invention is placed over the exterior of the end portion of the tool handle and secured to the handle in the aforementioned ways.

After attaching the invention to the handle of a finishing tool, the improved apparatus is used in the claimed method of boarding finishing by adjusting boarding attachment screws to optimal depths thereby creating the desired dimpling into which filling compound may be applied with the finishing tool without the operator having to switch tools.

Following the completing of the boarding attachment operation using screws, the invention, previously or contemporaneously attached to the handle of a finishing tool, is used to adjust the depth of the boarding attachment tools to the optimal depth, including the creation of any desired dimpling in the boarding. With the same tool in hand, the operator may proceed to apply filling compound to the boarding right away after adjusting individual screws or all of the screws over a given area of attached boarding, without having to fumble about for a second tool. The operator simply needs to reverse the orientation of the tool presently in hand to use the finishing tool by placing a suitable amount of filling compound onto the working, non-screwdriver end of the finishing tool, and proceed directly to apply the filling compound to dimples, holes, cracks and any other portions of the boarding requiring attention.

Not having to switch between tools benefits operators in such boarding finishing operations because less ergonomic movements are needed to complete the job, thereby reducing the change of injuries that may result from repetitive motion, and from distraction due to being required to look for and reach for additional tools. Due to the reduced number of steps needed, and the resulting reduction in time required to complete boarding finishing operations when practicing the claimed invention, the efficiency of such operations is significantly increased. For similar reasons, the ease of attachment and detachment of the claimed invention from the handles of filling tools as needed for specific jobs enhances operational efficiency and reduces the risk of operator discomfort and injury.

I claim:

1. A screw embedder attachment for a hand tool handle, comprising:
(a) an open ended base having a top portion and at least one side portions;
(b) a screwdriver bit attached at a single location on said base such that said bit points outwardly from said handle; and,
(c) a means for securing said base to said handle at the end of said handle opposite the working end of said tool;
wherein said screw embedder attachment is fabricated in one or more pieces, and whereby said screw embedder attachment is placed over the exterior of said handle of said tool prior to securing it to said handle of said tool.

2. The screw embedder attachment of claim 1, wherein:
said screwdriver bit is permanently attached to said top portion of said base at a right angle thereto.

3. The screw embedder attachment of claim 1, wherein:
said side portion of said base comprises two legs in a U-shaped configuration relative to said top portion of said base.

4. The screw embedder attachment of claim 3, wherein:
said U-shaped configuration may be flexed so as to accommodate varying handle sizes.

5. The screw embedder attachment of claim 1, wherein:
said side portion of said base comprises a cup configuration relative to said top portion of said base.

6. The screw embedder attachment of claim 5, wherein:
said cup configuration may be flexed so as to accommodate varying handle sizes.

7. The screw embedder attachment of claim 1, further comprising:
(d) at one hole in at least one location on said side portion through or upon which said means for securing is placed, said means for securing engaging through or upon one or more holes in said handle of said tool;
whereby said means for securing enables said screw embedder attachment to be assembled onto and disassembled from said handle of said tool without the need to disassemble or assemble said tool in any way.
